(19) United States
(12) Patent Application Publication
(10) Pub. No.: US 2023/0160595 A1
(43) Pub. Date: May 25, 2023

(54) Method and system for controlling air quality in an indoor environment of a building

(71) Applicant: Fybra S.r.l., Milano MI (IT)

(72) Inventors: Gaetano LAPENTA, Milano MI (IT); Marco SCARAMELLI, Milano MI (IT)

(21) Appl. No.: 17/988,828

(22) Filed: Nov. 17, 2022

(30) Foreign Application Priority Data
Nov. 19, 2021 (IT) 102021000029369

(51) Int. Cl. F24F 11/64; F24F 11/52; F24F 11/526; G05B 19/042

(52) U.S. Cl. CPC F24F 11/64; F24F 11/52; F24F 11/526; G05B 19/042; F24F 2110/66

(57) ABSTRACT

A method for controlling air quality in an indoor environment of a building comprises the steps of:
storing control values of carbon dioxide and/or volatile organic compound concentration;
detecting an instantaneous value of carbon dioxide concentration and sending it to a control unit (5);
detecting an instantaneous value of volatile organic compound concentration and sending it to the control unit (5);
processing the control values and the instantaneous values of carbon dioxide and volatile organic compound concentration to generate an output signal representative of the detected air quality;
sending the output signal to a visual and/or acoustic warning unit (7).

### TECHNICAL FIELD

The present disclosure relates to a method and a corresponding system for controlling the air quality in an indoor environment of a building by means of natural ventilation.

### PRIOR ART

It is known that human respiration involves the inhalation of the oxygen present in the air and the corresponding release of carbon dioxide into the air. In addition, other components which are potentially harmful to humans are released into the environment, such as what is known as VOCs (Volatile Organic Compounds). Therefore, in overcrowded and not properly ventilated indoor environments, there could be a rapid increase in the level of carbon dioxide concentration and a progressive and parallel increase in VOCs. A high carbon dioxide concentration in the air of the indoor environment leads to negative consequences for humans, namely malaise, difficulty in concentration and decreased performance, as well as prolonged exposure to significant VOC values. Furthermore, already for values of carbon dioxide concentration above 800-1000 ppm, man perceives a sensation of stale air that can significantly compromise his activity. It should be noted that VOCs, unlike CO2, are not exclusively produced by human respiration, so their increase in the environment can be found even in the absence of people, for example in the presence of certain types of furniture or paints.

In order to measure and quantify the air quality of the indoor environment, the use of a carbon dioxide sensor is known in the literature. Such a carbon dioxide sensor is configured to detect an instantaneous value of carbon dioxide concentration in the air of the indoor environment, i.e., to continuously monitor the carbon dioxide concentration of the indoor environment. The instantaneous level of carbon dioxide concentration is then sent to a device for controlling the ventilation of the indoor environment of the building, if present, so as to properly ventilate the indoor environment in the event of an excessive increase in the level of carbon dioxide concentration. The measurement of carbon dioxide concentration is usually used to quantify the amount of carbon dioxide in the environment and if there are no management and control systems of the ventilation of the indoor environment, there will be no impact on the air quality.

A temperature sensor is also known in the prior art, configured to detect an instantaneous value of air temperature of an indoor environment of a building. Traditionally, the measurement made by the temperature sensor is used exclusively to control the heating system of the indoor environment of the building or simply to give the user information about the temperature value.

VOC sensors are also known per se in the prior art.

Documents CN 110925946 and EP 3855087 are further known in the prior art. Such documents describe a method for controlling air quality of an indoor environment of a building comprising the steps of the preamble of claim 1.

### Problem of the Prior Art

Disadvantageously, the solutions for monitoring air quality of the prior art, including those made by the same Applicant, are incomplete since they fail to take into account the impact of VOCs in combination with the carbon dioxide concentration, temperature and relative humidity.

### SUMMARY OF THE INVENTION

In this context, the technical task underlying the present invention is to provide a method and a system for controlling air quality in an indoor environment of a building which overcome the drawbacks of the prior art.

In particular, it is an object of the present invention to propose a method and a corresponding system which allow to communicate the air quality level in a short time to a user of the indoor environment of the building and which allow to identify, in an adaptive manner, the optimal natural ventilation time in that specific moment, in that specific environment and with those specific conditions.

Furthermore, it is an object of the present invention to propose a method and a corresponding system which also allow the temperature value of the indoor environment to be used to determine the instantaneous and future air quality level.

The mentioned technical task and the specified objects are substantially achieved by a method for controlling the air quality in an indoor environment of a building comprising the steps set out in one or more of the appended claims and a corresponding system comprising the technical features set out in one or more of the appended claims.

### BRIEF DESCRIPTION OF THE DRAWINGS

Further features and advantages of the present invention will become clearer from the indicative, and therefore non-limiting, description of a preferred but non-exclusive embodiment of a method and of a system for controlling air quality in an indoor environment of a building, as illustrated in the accompanying drawings in which:

FIG. 1 is a schematic depiction of the system in accordance with an embodiment of the present invention.

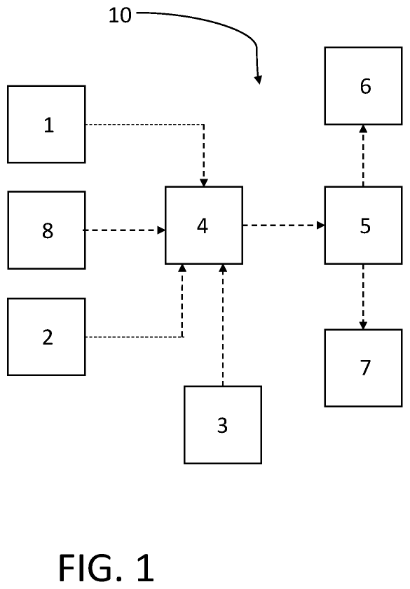

### DETAILED DESCRIPTION

With particular reference to the accompanying drawing, the number 10 indicates a system for controlling the air quality in an indoor environment of a building. This system 10 comprises a temperature sensor 1 configured to detect an instantaneous value of air temperature in the indoor environment of the building. In other words, the temperature sensor 1 is configured to continuously measure the temperature of the indoor environment of the building. Preferably, such a temperature sensor 1 is provided with a humidity sensor 3 configured to measure the humidity of the air of the indoor environment.

In addition, the system 10 comprises a carbon dioxide sensor 2 configured to detect an instantaneous value of carbon dioxide concentration of the air of the indoor environment of the building. In other words, the carbon dioxide sensor 2 is configured to continuously measure the carbon dioxide concentration of the air of the indoor environment. The carbon dioxide sensor 2 is capable of performing an automatic calibration of the measurement by virtue of a comparison chamber.

The system 10 further comprises a volatile organic compound sensor 8, which is configured to detect an instantaneous value of volatile organic compound concentrations (VOCs) in the air of the indoor environment of the building. In other words, the volatile organic compound sensor 8 is configured to continuously measure the VOC concentration in the air of the indoor environment.

The system 10 comprises a control unit 5 in signal communication with the temperature sensor 1 and/or with the carbon dioxide sensor 2 and/or with the volatile organic compound sensor 8. The system 10 further comprises a communication unit 4 for communicating a signal between the temperature sensor 1 and/or the carbon dioxide sensor 2 and/or the volatile organic compound sensor 8 with the control unit 5.

Furthermore, the system 10 comprises a storage unit 6 in signal communication with the control unit 5.

It should be noted that both the control unit 5 and the storage unit 6 can be local, i.e., placed in a device, not illustrated in the accompanying drawings, also comprising the temperature sensor 1, the carbon dioxide sensor 2, the volatile organic compound sensor 8 and the communication unit 4. Alternatively, both the control unit 5 and the storage unit 6 can be remote, i.e., operating in the cloud.

It is further an object of the present disclosure a method for controlling the air quality in an indoor environment of a building via the system 10.

The method comprises the step of defining and storing in the storage unit 6 via the control unit 5 control values of carbon dioxide and volatile organic compound concentration.

In particular, the defining and storing step comprises the step of defining and storing in the storage unit 6 an activation value of carbon dioxide concentration. It should be noted that, if the indoor environment is not frequented by people at a given moment, the instantaneous value of carbon dioxide concentration at that given moment is presumably lower than the activation value of carbon dioxide concentration.

A critical activation value of carbon dioxide concentration is also stored in the storage unit 6. Such a critical value of carbon dioxide concentration is higher than the activation value of carbon dioxide. The critical value of carbon dioxide concentration is initially equal to a value considered appropriate for the intended use and the general crowding of the indoor environment. The critical value of carbon dioxide concentration is expressed in ppm. It should be noted that, once the critical value of carbon dioxide concentration in the indoor environment has been exceeded, it is advisable to ventilate such an indoor environment by opening, for example, a window, i.e., performing a natural ventilation operation.

An acceptable value of carbon dioxide concentration is also stored in the storage unit 6 after the critical value of carbon dioxide concentration has been reached and, therefore, an air quality improvement phase, for example, following the natural ventilation. Such an acceptable value of carbon dioxide concentration is less than the critical value of carbon dioxide concentration and is greater than the activation value of carbon dioxide concentration. Preferably, such an acceptable value of carbon dioxide concentration is initially equal to a value considered appropriate in the specific geographical and environmental condition and given the intended use and the typical crowding of the indoor environment. Such an acceptable value of carbon dioxide concentration is expressed in ppm. It should be noted that, once the acceptable value of carbon dioxide concentration in the indoor environment has been reached during a ventilation step of the indoor environment, it is no longer necessary to ventilate such an indoor environment and it is therefore possible, for example, to close the window (action signalled by the restoration of the alert colour/activation).

With regard to volatile organic compounds, the method comprises the step of defining a first critical threshold of volatile organic compound concentration and, in particular, storing it within said storage unit 6.

The method further comprises the step of defining a second critical threshold of volatile organic compound concentration. Such a second critical threshold is in particular a higher value than the first critical threshold.

It is important to emphasize that if the values of carbon dioxide concentration were subject to sudden changes, i.e., a continuous achievement of the critical value of carbon dioxide concentration and subsequent decrease to the acceptable value of carbon dioxide concentration, a continuous and repeated intervention by the user (opening/closing the window) could be generated which would be annoying. It will therefore be necessary to define thresholds which also consider this latency time.

The method further comprises the step of detecting via the carbon dioxide sensor 2 an instantaneous value of carbon dioxide concentration and sending, via the communication unit 4, said instantaneous value of carbon dioxide concentration to the control unit 5.

The method further comprises the step of detecting via the volatile organic compound sensor 8 an instantaneous value of volatile organic compound concentration and sending, via the communication unit 4, such a value to the control unit 5.

It should be noted that the step of detecting an instantaneous value of volatile organic compound concentration is performed when the carbon dioxide concentration is higher than the activation value of carbon dioxide concentration.

Otherwise, i.e., if the carbon dioxide concentration is lower than an activation value of carbon dioxide concentration, the step of detecting an instantaneous value of volatile organic compound concentration is not performed. Accordingly, even if the value of the volatile organic compound concentration is detected by the sensor, it is neglected in the calculation of the parameters indicated below.

Further details regarding the detection of the volatile organic compound concentration will be provided in a later part of the present disclosure.

It should be noted that the sensors 2, 8 are configured to continuously detect the concentration value in the indoor environment and to continuously send such values to the control unit 5.

Subsequently, the method comprises the step of detecting, via the temperature sensor 1, an instantaneous value of air temperature of the indoor environment and sending, via the communication unit 4, said instantaneous value of temperature to the control unit 5. It should be noted that the temperature sensor 1 is configured to continuously detect the air temperature value of the indoor environment and to continuously send such a temperature value to the control unit 5.

The method comprises the step of defining, via the control unit 5, a refresh time interval comprising a plurality of time points. Preferably, said refresh time interval corresponds to the time period between two successive ventilations of the indoor environment of the building.

The method further comprises the step of storing in the storage unit 6, via the control unit 5, an instantaneous value of temperature for each time point of the refresh time interval to define a set of instantaneous values of temperature.

Next, the method comprises the step of storing in the storage unit 6, via the control unit 5, an instantaneous value of carbon dioxide concentration for each time point of the refresh time interval to define a set of instantaneous values of carbon dioxide concentration.

According to the preferred embodiment, the method comprises the step of defining, via the control unit 5, a reference value of temperature. For example, such a reference value of temperature is 18° C. Alternatively, the reference value of temperature can be different, in particular it can vary as a function of the user's needs, geographical location and climate. For example, during the summer season in a temperate climate the reference value of temperature can be 26° C.

The method further comprises the step of analysing, via the control unit 5, the set of instantaneous values of temperature to define a maximum value of temperature between the instantaneous values of temperature and the step of analysing, via the control unit 5, the set of instantaneous values of temperature to define a rate of decrease of temperature.

The method further comprises the step of defining, by means of the control unit 5, a maximum air purification time interval as a function of the maximum value of temperature, the reference value of temperature and the rate of decrease of temperature. The maximum purification time interval represents a maximum ventilation time of the indoor environment so as not to fall below the reference value of temperature. Preferably, the first maximum air purification time interval is defined by the control unit 5 in accordance with the following expression:

$$t max [ min ] = \frac{T max - Tref}{{vT}^{-}}$$

### Where:

tmax: maximum air purification time interval;
Tmax: maximum value of temperature;
Tref: reference value of temperature;
vT⁻=rate of decrease of temperature.

With reference to the detection of the volatile organic compounds, the method according to the present disclosure envisages that, if the time elapsed since the last ventilation of the environment is greater than the maximum air purification time interval and the volatile organic compound concentration is greater than the first critical threshold, an output signal indicative of the need to ventilate the environment is sent.

Furthermore, if the time since the last ventilation of the environment is less than the maximum air purification time interval and the volatile organic compound concentration is greater than the second critical threshold, an output signal indicative of the need to ventilate the environment is likewise sent.

In accordance with the preferred embodiment of the disclosure, the method comprises the step of defining, via the control unit 5, a reference time interval and a comfort value of carbon dioxide concentration of the air of the indoor environment of the building. Such a reference time interval represents a minimum time interval which must pass for ventilation of the indoor environment. It should be noted that such a reference time interval is set as an initial value at 10 min, but that this value can vary depending on the customer, the season and the specific conditions of the indoor environment. The comfort value of carbon dioxide concentration represents a value of carbon dioxide concentration of the air of the indoor environment such as to not affect the performance and concentration of a user of the indoor environment.

In addition, the method further comprises the step of analysing, via the control unit 5, the set of instantaneous values of carbon dioxide concentration to define a rate of increase of carbon dioxide concentration.

The method further comprises the step of calculating, via the control unit 5, an effective time interval as a function of the critical value of carbon dioxide concentration, the acceptable value of carbon dioxide concentration and the rate of increase of carbon dioxide concentration. Preferably, the actual time interval is calculated via the control unit in accordance with the following expression:

$$tblu max [ min ] = \frac{Va - Vc}{v CO {2}^{+}}$$

### Where:

tblumax [min]: actual time interval;
Va: critical value of carbon dioxide concentration;
Vc: acceptable value of carbon dioxide concentration;
vCO2⁺=rate of increase of carbon dioxide concentration.

It should be noted that if the rate of increase of the carbon dioxide concentration is zero, such an actual time interval is set, via the control unit 5, to a high value such as, for example, 30 min.

After the step of calculating the actual time interval, the method comprises the step of comparing, via the control unit 5, the actual time interval with the reference time interval.

After the step of comparing the actual time interval with the reference time interval, the method comprises the step of updating, via the control unit 5, the acceptable value of carbon dioxide concentration as a function of the comfort value of carbon dioxide concentration, the reference time interval, the actual time interval and the rate of increase of carbon dioxide concentration, if the actual time interval is less than the reference time interval. Preferably, the acceptable value of carbon dioxide concentration is updated, via the control unit 5, in accordance with the following expression:

$$Vcnew = CO 2 c - \frac{tref - tblu max}{v CO {2}^{+}}$$

Vcnew: acceptable value of carbon dioxide concentration after updating via the control unit 5;
CO2c: comfort value of carbon dioxide concentration;
tref: reference time interval;
tblumax: actual time interval;
vCO2⁺: rate of increase of carbon dioxide concentration.

The acceptable value of carbon dioxide concentration after the updating is stored in the storage unit 6 in place of the previous acceptable value of carbon dioxide concentration.

If, instead, the actual time interval is greater than or equal to the reference time interval, the acceptable value of carbon dioxide concentration is not updated by the control unit 5, i.e., it remains equal to the acceptable value of carbon dioxide concentration stored in the storage unit 6.

In accordance with the preferred embodiment of the disclosure, the method comprises, after the step of updating the acceptable value of carbon dioxide concentration and before step c), the step of defining, via the control unit 5, a value of carbon dioxide concentration outside the building. Preferably, such a value of carbon dioxide concentration is measured via a carbon dioxide concentration detection device located outside the building.

After the step of defining an external value of carbon dioxide concentration, the method comprises the step of comparing, via the control unit 5, the acceptable value of carbon dioxide concentration with the external value of carbon dioxide concentration.

After the step of comparing, via the control unit 5, the acceptable value of carbon dioxide concentration with the external value of carbon dioxide concentration, the method comprises the step of updating, via the control unit 5, the acceptable value of carbon dioxide concentration as a function of the external value of carbon dioxide concentration, if the acceptable value of carbon dioxide concentration exceeds the external value of carbon dioxide concentration by a value equal to a specific value of carbon dioxide concentration, preferably 200 ppm. Preferably, the acceptable value of carbon dioxide concentration is updated, via the control unit 5, in accordance with the following expression:

Vcnew=Ve+200

Vcnew: acceptable value of carbon dioxide concentration after updating via control unit 5;
Ve: external value of carbon dioxide concentration.

Still after the step of comparing, via the control unit 5, the acceptable value of carbon dioxide concentration with the external value of carbon dioxide concentration, the method comprises the step of updating, via the control unit 5, the critical value of carbon dioxide concentration as a function of the critical value of carbon dioxide concentration stored in the storage unit 6, the reference time interval, the external value of carbon dioxide concentration and the rate of increase of carbon dioxide concentration, if the acceptable value of carbon dioxide concentration exceeds the external value of carbon dioxide concentration by a value equal to the specific value of carbon dioxide concentration. Preferably, the critical value of carbon dioxide concentration is updated, via the control unit 5, in accordance with the following expression:

$$Vanew = Va + \frac{tref - ( Va - ( Ve + 200 ) )}{v CO {2}^{+}}$$

Where:

Vanew: critical value of carbon dioxide concentration after updating via the control unit 5;
tref: reference time interval;
Va: critical value of carbon dioxide concentration stored in the storage unit 6;
Ve: external value of carbon dioxide concentration;
vCO2⁺: rate of increase of carbon dioxide concentration.

The acceptable value of carbon dioxide concentration and the critical value of carbon dioxide concentration after the update are stored in the storage unit 6 in place of the previous acceptable value of carbon dioxide concentration and the previous critical value of carbon dioxide concentration, respectively.

If, instead, the acceptable value of carbon dioxide concentration does not exceed the external value of carbon dioxide concentration by a value equal to the specific value of carbon dioxide concentration, the acceptable value of carbon dioxide concentration and the critical value of carbon dioxide concentration are not updated by the control unit, i.e., they remain equal, respectively, to the acceptable value of carbon dioxide concentration and the critical value of carbon dioxide concentration stored in the storage unit 6.

In accordance with the preferred embodiment of the disclosure, the method comprises, after the step of updating the critical and acceptable values of carbon dioxide concentration and prior to step c), the further step of defining, via the control unit 5, an air purification time interval as a function of the critical value of carbon dioxide concentration, the acceptable value of carbon dioxide concentration and the rate of decrease of carbon dioxide concentration. Such an air purification time interval represents the period of time necessary to ventilate the indoor environment considering the acceptable value and the critical value of carbon dioxide concentration updated via the control unit 5. Preferably, the air purification time interval is defined by the control unit 5 in accordance with the following expression:

$$ta = \frac{Vanew - Vcnew}{v CO {2}^{-}}$$

ta: air purification time interval;
Vanew=critical value of carbon dioxide concentration after updating via the control unit 5;
Vcnew=acceptable value of carbon dioxide concentration after updating via the control unit 5;
vCO2⁻=rate of decrease of carbon dioxide concentration.

After the step of defining, via the control unit 5, an air purification time interval, the method comprises the step of defining, via the control unit 5, a minimum temperature value which can be reached as a function of the maximum temperature value, the purification time interval and the rate of decrease of temperature. Preferably, the minimum reachable temperature value is defined via the control unit 5 in accordance with the following expression:

Tmin period=Tmax−(ta*vT−)

Where:

Tmin period=minimum reachable temperature value;
Tmax=maximum temperature value of the set of instantaneous values of temperature;
ta=air purification time interval;
vT⁻=rate of decrease of temperature;

After the step of defining, via the control unit 5, a minimum reachable temperature value, the method comprises the step of comparing, via the control unit 5, the minimum reachable temperature value with the reference value of temperature.

After the step of comparing, via the control unit 5, the minimum reachable temperature value with the reference value of temperature, the method comprises the step of updating, via the control unit 5, the acceptable value of carbon dioxide concentration as a function of the critical value of carbon dioxide concentration, the air purification time interval and the rate of decrease of carbon dioxide concentration, if the minimum reachable temperature value is less than the reference value of temperature. Preferably, the acceptable value of carbon dioxide concentration is updated via the control unit 5 in accordance with the following expression:

Vcnew=Vanew−(ta−1)*vCO2⁻

Where:

Vcnew: acceptable value of carbon dioxide concentration after updating via the control unit 5;
Vanew: critical value of carbon dioxide concentration;
ta: air purification time interval;
vCO2⁻: rate of decrease of carbon dioxide concentration.

The acceptable value of carbon dioxide concentration after the updating is stored in the storage unit 6 in place of the previous acceptable value of carbon dioxide concentration stored in the storage unit 6.

If, instead, the minimum reachable temperature value is greater than or equal to the reference value of temperature, the acceptable value of carbon dioxide concentration is not updated, i.e., it remains equal to the acceptable value of carbon dioxide concentration stored in the storage unit 6.

It should be noted that, by updating the acceptable and critical values of carbon dioxide concentration according to the instantaneous values of temperature and carbon dioxide concentration detected, a preliminary calibration step is not necessary according to the specific features of the indoor environment. In other words, the method does not require a calibration step based on the dimensional parameters of the indoor environment, the number and dimensions of the ventilation sources (doors and windows) and the number of people attending such an indoor environment. In essence, the update of the acceptable and critical values of carbon dioxide concentration allows, independently of the specific features of the indoor environment, to communicate to the users the air quality level of the indoor environment, whether it is necessary to ventilate the indoor environment and for how long it is necessary to ventilate such an indoor environment, also indicating in real time the actual effectiveness of the ventilation applied. All in compliance with the principles of comfort and energy efficiency.

Next, the method comprises the step of processing via the control unit 5 the control values and the instantaneous concentration values to generate an output signal representative of the processing performed by the control unit 5. In other words, the output signal generated by the control unit 5 is representative of an instantaneous level of air quality of the indoor environment. It should be noted that, the control unit 5 is configured to continuously process the control values and the instantaneous concentration values to generate the output signal. Such an output signal can change depending on the instantaneous air quality level of the indoor environment, i.e., depending on the instantaneous values of carbon dioxide and volatile organic compound concentration.

Also in accordance with the preferred embodiment of the disclosure, the processing step comprises a sub-step of comparing the instantaneous value of carbon dioxide concentration with the activation value of carbon dioxide concentration, with the critical value of carbon dioxide concentration and with the acceptable value of carbon dioxide concentration.

The output signal is representative of a first alert as long as the instantaneous value of carbon dioxide concentration is lower than the activation value of carbon dioxide concentration. The first alert is representative of a first level of air quality of the indoor environment. As long as the output signal is representative of the first level of air quality of the indoor environment it means, presumably, that there is no person in the indoor environment.

The output signal is representative of a second alert as long as the instantaneous value carbon dioxide concentration is higher than the activation value of carbon dioxide concentration and is lower than the critical value of carbon dioxide concentration. Such a second alert is representative of a second level of air quality of the indoor environment. If the output signal is representative of the second level of air quality, it is not necessary to ventilate the indoor environment.

The output signal is representative of a third alert as long as the instantaneous value of carbon dioxide concentration is higher than the critical value of carbon dioxide concentration and the instantaneous value of carbon dioxide concentration remains constant or increasing over time. Such a third alert is representative of a third level of air quality of the indoor environment. If the output signal is representative of the third level of air quality, the user of the indoor environment knows that it is necessary to ventilate such an indoor environment, for example by opening a window.

The output signal is representative of a fourth alert after the instantaneous value of carbon dioxide concentration has exceeded the critical value of carbon dioxide concentration and as long as the instantaneous value of carbon dioxide concentration decreases with time and is higher than the acceptable value of carbon dioxide concentration. Such a fourth alert is representative of a fourth level of air quality of the indoor environment. If the output signal is representative of the fourth alert, it means that the user is ventilating the indoor environment, for example by opening a window, i.e., the air quality of the indoor environment is improving. Furthermore, as long as the output signal is representative of the fourth level of air quality, the user understands that it is necessary to continue to ventilate the indoor environment. Consequently, the user can understand how long it is necessary to ventilate the indoor environment in those specific conditions, i.e., in that time point, with that number of people in the indoor environment and those determined conditions of use.

After a ventilation step, i.e., when the instantaneous value of carbon dioxide concentration falls below the acceptable value of carbon dioxide concentration and remains higher than the activation value of carbon dioxide, the output signal is again representative of the second alert.

It should therefore be emphasized that the time in which it is necessary to ventilate the indoor environment is the time elapsing between the point in which the output signal is representative of the fourth alert and the point in which the output signal returns to be representative of the second alert.

It should also be noted that the output signal is configured to carry the first, second, third, and fourth alerts, respectively.

Still in accordance with the preferred embodiment of the disclosure, the processing step comprises defining, via the control unit 5, a critical time interval corresponding to the time period in which the output signal is representative of the fourth alert. In other words, the critical time interval is the time period in which the indoor environment must be ventilated.

After the processing step, the method comprises the step of sending, via the control unit 5, the output signal to a visual and/or acoustic warning unit 7. Preferably, such a warning unit 7 is placed inside the indoor environment in a position easily consultable by a user of the indoor environment. The output signal generated by the control unit 5 controls the visual and/or acoustic warning unit 7. Such a warning unit 7 changes its warning state based on the output signal. Accordingly, the user of the indoor environment, by controlling the warning state of the warning unit 7 is able to deduce the instantaneous level of air quality of the indoor environment.

According to a first embodiment of the disclosure, the sending step comprises the step of sending the output signal from the control unit (5) to a light source. The first, second, third and fourth alerts respectively correspond to a first, second, third and fourth colour and/or light intensity emitted by the light source. For example, the first alert corresponds to a shade of white, the second alert corresponds to a shade of cyan, the third alert corresponds to a shade of red, while the fourth alert corresponds to a shade of fuchsia, preferably flashing fuchsia. It should therefore be noted that the user, by controlling the light colour emitted by the light source, is capable of immediately checking the air quality of the indoor environment. In fact, in accordance with what has been previously introduced, if the colour emitted by the light source is white or cyan, the user understands that it is not necessary to ventilate the indoor environment, while if the colour emitted by the source is red, the user understands that it is necessary to ventilate the indoor environment and, following the flashing of the fuchsia light, perceives how long it is necessary to ventilate the indoor environment until the cyan colour is restored.

In accordance with a second alternative embodiment and/or combinable with the first embodiment of the disclosure, the sending step comprises the step of sending the output signal from the control unit 5 to a sound source. The first, second, third and fourth alerts correspond to a first, second, third and fourth pitch and/or sound intensity, respectively. Preferably:
the output signal carrying the second alert is sent to the sound source upon switching from the first to the second alert and/or upon switching from the fourth to the second alert;
the output signal carrying the third alert is sent to the sound source upon switching from the second to the third alert;
the output signal carrying the fourth alert is sent to the sound source upon switching from the third to the fourth alert;
the output signal carrying the first alert is sent to the sound source upon switching from the second alert to the first alert.

Alternatively, each sound output signal can be issued as a voice message.

In addition, the step of sending the output signal comprises the step of comparing, via the control unit 5, the critical time interval with the maximum air purification time interval.

The step of sending the output signal also comprises the step of setting the output signal on the second alert if the critical time interval exceeds the maximum air purification time interval. In other words, regardless of the result of the comparison between the instantaneous value of carbon dioxide concentration and the critical and acceptable values of carbon dioxide concentration, if the critical time interval exceeds the maximum air purification time interval, the output signal carries the second alert, i.e., it is no longer necessary to ventilate the indoor environment.

1. A method of controlling air quality in an indoor environment of a building by a system that comprises a carbon dioxide sensor configured to detect an instantaneous value of carbon dioxide concentration in the air of the indoor environment of the building, a volatile organic compound sensor configured to detect an instantaneous value of volatile organic compounds in the air of the indoor environment of the building, a control unit in signal communication with the carbon dioxide sensor and with the volatile organic compound sensor a communication unit for establishing signal communication between the carbon dioxide sensor and the volatile organic compound sensor on the one hand and the control unit on the other hand, a storage unit in signal communication with the control unit, the method comprising the steps of:
storing control values of carbon dioxide concentration and/or volatile organic compounds in the storage unit;
detecting, by the carbon dioxide sensor, an instantaneous value of carbon dioxide concentration and sending to the control unit,
detecting by the volatile organic compound sensor an instantaneous value of volatile organic compound concentration and sending it to the control unit;
processing, by the control unit, the control values and the instantaneous values of carbon dioxide and volatile organic compound concentration to generate an output signal representative of the air quality detected by the sensors;
sending the output signal to a visual and/or acoustic warning unit.
wherein it comprises the additional steps of:
defining a maximum air purification time interval corresponding to the maximum duration of an environment ventilation step;
defining a first critical threshold for volatile organic compound concentration;
defining a second critical threshold for volatile organic compound concentration whose value is higher than the first critical threshold;
determining, when volatile organic compound detection is being performed, whether the time elapsed since the last environment ventilation is more than the maximum air purification time interval and volatile organic compound concentration is higher than the first critical threshold, and when this is determined to be so, sending an output signal indicative of the need to perform environment ventilation.

2. The method as claimed in claim 1, wherein when volatile organic compound detection is being performed, if the time elapsed since the last environment ventilation is less than the maximum air purification time interval and the concentration of volatile organic compounds is higher than the second critical threshold, an output signal is sent, indicating the need to perform environment ventilation.

3. A method as claimed in claim 1, wherein the step of detecting an instantaneous value of volatile organic compound concentration is carried out when carbon dioxide concentration is higher than an activation value of carbon dioxide concentration.

4. A method as claimed in claim 1, wherein the step of detecting an instantaneous value of volatile organic compound concentration is not carried out when carbon dioxide concentration is lower than an activation value of carbon dioxide concentration.

5. A method as claimed in claim 1, wherein the step of storing control values of carbon dioxide and/or volatile organic compounds concentration in the storage unit comprises the steps of:
storing in the storage unit said activation value of carbon dioxide concentration;
storing in the storage unit a critical value of carbon dioxide concentration; said critical value of carbon dioxide concentration being greater than said activation value of carbon dioxide;
storing in the storage unit an acceptable value of carbon dioxide concentration, said acceptable value of concentration being smaller than the critical value of carbon dioxide concentration and greater than the activation value of carbon dioxide concentration.

6. A method as claimed in claim 5, wherein step of processing comprises the step of comparing the instantaneous value of carbon dioxide concentration with the activation value of carbon dioxide concentration, with the critical value of carbon dioxide concentration and with the acceptable value of carbon dioxide concentration; wherein
the output signal is representative of a first alert as long as the instantaneous value of carbon dioxide concentration is lower than the activation value of carbon dioxide concentration;
the output signal is representative of a second alert as long as the instantaneous value of carbon dioxide concentration value is higher than the activation value of carbon dioxide concentration and is lower than the critical value of carbon dioxide concentration;
the output signal is representative of a third alert as long as the instantaneous value of carbon dioxide concentration is higher than the critical value of carbon dioxide concentration and said instantaneous value of carbon dioxide concentration remains constant or increases with time;
the output signal is representative of a fourth alert once the instantaneous value of carbon dioxide concentration has exceeded the critical value of carbon dioxide concentration and as long as the instantaneous value of carbon dioxide concentration decreases with time and is higher than the acceptable value of carbon dioxide concentration.

7. A method as claimed in claim 6, wherein the system further comprises a temperature sensor configured to detect an instantaneous value of air temperature in the indoor environment, said temperature sensor being in signal communication with the control unit via the communication unit, said method comprising the additional steps of:
detecting, by the temperature sensor, an instantaneous value of air temperature in the indoor environment and sending, by the communication unit said instantaneous value of temperature to the control unit;
defining, by the control unit, a refresh time interval comprising a plurality of time points;
storing in the storage unit, by the control unit, an instantaneous value of temperature for each time point of the refresh time interval to define a set of instantaneous values of temperature;
storing in the storage unit, by the control unit, an instantaneous value of carbon dioxide concentration for each time point of the refresh time interval to define a set of instantaneous values of carbon dioxide concentration.

8. A method as claimed in claim 7, wherein it comprises the additional steps of:
defining, by the control unit, a reference value of temperature;
analyzing, by the control unit, the set of instantaneous values of temperature to determine a maximum value of temperature from said instantaneous values of temperature;
analyzing, by the control unit, the set of instantaneous values of temperature to determine a rate of decrease of temperature;
defining, by the control unit, said maximum air purification time interval according to the maximum value of temperature, the reference value of temperature and the rate of decrease of temperature;
and the step of processing comprises the sub-steps of:
defining, by the control unit, a critical time interval corresponding to the period of time in which the output signal is representative of the fourth alert;
comparing, by the control unit, the critical time interval with the maximum air purification time interval;
setting the output signal to the second alert if the critical time interval exceeds the maximum air purification time interval.

9. A method as claimed in claim 1, wherein the step of sending an output signal comprises the sub-step of sending the output signal from the control unit to a light source, the first, second, third and fourth alerts corresponding to a first, a second, a third and a fourth light colors and/or intensities that can be emitted from the light source respectively.

10. A method as claimed in claim 1, wherein the step of sending an output signal comprises the sub-step of sending the output signal from the control unit to a sound source, the first, second, third and fourth alerts corresponding to a first, a second, a third and a fourth sound tones and/or intensities and/or to a first and/or a second and/or a third and/or a fourth voice message.

11. A system configured to carry out the method according to claim 1, said system comprising:
a temperature sensor configured to detect an instantaneous value of temperature of air in the indoor environment of the building;
a carbon dioxide sensor configured to detect an instantaneous value of carbon dioxide concentration of air in the indoor environment of the building;
a volatile organic compound sensor configured to detect an instantaneous value of volatile organic compound concentration of air in the indoor environment of the building;
a control unit in signal communication with the temperature sensor and with the carbon dioxide sensor;
a communication unit for establishing signal communication between the temperature, carbon dioxide and volatile organic compound sensors on the one hand and the control unit on the other hand, said communication unit being configured to send instantaneous values of temperature, carbon dioxide and volatile organic compounds to the control unit;
a storage unit in signal communication with the control unit and configured to store control values of carbon dioxide and volatile organic compound concentration;
wherein the control unit is configured to process the control values and the instantaneous values of carbon dioxide and volatile organic compound concentration to generate an output signal representative of the air quality detected by the sensors and to send the output signal to a visual and/or acoustic warning unit.
